(19) United States
(12) Patent Application Publication
(10) Pub. No.: US 2021/0271099 A1
(43) Pub. Date: Sep. 2, 2021

(54) TRANSMISSION DEVICE, AND SYSTEM INCLUDING THE TRANSMISSION DEVICE

(71) Applicant: Osaka University, Suita-shi (JP)

(72) Inventors: Naoya Kukutsu, Tokyo (JP); Masato Kikuchi, Tokyo (JP); Tadao Nagatsuma, Suita-shi (JP); Masayuki Fujita, Suita-shi (JP); Daniel Jonathan Headland, Suita-shi (JP); Tomoki Sagisaka, Suita-shi (JP); Li Yi, Suita-shi (JP)

(73) Assignee: Osaka University, Suita-shi (JP)

(21) Appl. No.: 17/185,636

(22) Filed: Feb. 25, 2021

(30) Foreign Application Priority Data
Feb. 27, 2020 (JP) 2020-032001

(51) Int. Cl. G02B 27/14; H04B 10/50; H04B 10/60; G02B 27/28

(52) U.S. Cl. CPC G02B 27/14; G02B 27/283; H04B 10/60; H04B 10/50

(57) ABSTRACT

The transmission device of the present embodiment includes a waveguide unit which transmits a terahertz-wave signal, and a plurality of ports provided around the waveguide unit and each composed of a waveguide and a planar lens, the waveguide unit and the ports being integrated on a planar substrate with dielectric properties. The planar lens diffuses, in an arcuate shape, a terahertz-wave signal by a reflective index set by a staggering arrangement of first through-holes, transmits the diffused terahertz-wave signal to the waveguide unit in parallel, or focuses a terahertz-wave signal which is transmitted in parallel through the waveguide unit. A beam splitter transmits a terahertz-wave signal, which is transmitted in parallel from a first planar lens, to a second planar lens, by reflection or transmission by a refractive index set by a grid arrangement of second through-holes.

### CROSS-REFERENCE TO RELATED APPLICATIONS

This application is based upon and claims the benefit of priority from Japanese Patent Application No. 2020-032001, filed Feb. 27, 2020, the entire contents of which are incorporated herein by reference.

### BACKGROUND

Embodiments of the present invention relate to a transmission device which is formed on a substrate with dielectric properties and transmits a terahertz-wave signal that is transmitted and received, and to a system including the transmission device.

In recent years, in wireless communication technology and image technology, there are proposed systems utilizing signals of terahertz waves (approximately 100 GHz to 100 THz). If a terahertz-wave signal is used for wireless communication technology, the amount of data transmitted increases, and if a terahertz-wave signal is used for image technology, a through-vision inspection or a nondestructive inspection can be performed without exposure by X rays, and an image with a higher resolution and a higher fineness can be acquired than in the case of microwaves

For example, Patent Literature 1 (Jpn. Pat. Appln. KOKAI Publication No. 2006-91802) proposes a terahertz electromagnetic wave generating apparatus as a system which generates the above-described terahertz-wave signal. This system includes a transmission mechanism which transmits a terahertz-wave signal generated by a transmitter and emits the terahertz-wave signal toward a target, and transmits a reflective signal or a scattering signal of the terahertz-wave signal to a receiver.

In this transmission mechanism, a spatial optical system is constructed by combining a waveguide, and a plurality of optical elements including a mirror and a lens. When the optical elements are combined, in order to construct a single transmission path up to the target, it is necessary to perform work for fine position adjustment and angle adjustment for the respective optical elements, and to provide support components which movably support the optical elements, leading to an increase in size of the system.

### SUMMARY

According to an embodiment of the present invention, there is provided a transmission device comprising: a first waveguide formed on a planar substrate with dielectric properties, having a width set by a frequency of a terahertz-wave signal, and configured to propagate the terahertz-wave signal; and a first planar lens including a first hole array formed in the substrate and arranged in a staggering manner, connected to the first waveguide to transmit and receive the terahertz-wave signal, and configured to diffuse the terahertz-wave signal that passes, and to convert the passing terahertz-wave signal into parallel waves, or configured to focus the terahertz-wave signal of parallel waves that pass, by a first refractive index set by hole diameters of the first through-holes and an inter-hole distance of the first through-holes.

In addition, an embodiment according to the transmission device comprises: the first waveguide configured to propagate the terahertz-wave signal; and the first planar lens configured to diffuse the terahertz-wave signal in an arcuate shape, and to convert the terahertz-wave signal into parallel waves, and the transmission device further comprises: a transmission path connected to the first planar lens on the substrate and configured to transmit the terahertz-wave signal converted into the parallel waves from the first planar lens; a second planar lens formed on the substrate, connected to the transmission path, including the first through-holes arranged in the staggering manner, and configured to focus, with respect to the passing terahertz-wave signal, the terahertz-wave signal of the parallel waves transmitted from the transmission path, by the first refractive index set by the first through-holes, or configured to diffuse a reflective signal of the terahertz-wave signal by the first refractive index, and to convert the reflective signal into parallel waves; and a second waveguide formed on the substrate, connected to the second planar lens, having a width set by a frequency of the focused terahertz-wave signal, and configured to output the terahertz-wave signal which is input from the second planar lens, or configured to propagate a reflective signal of the terahertz-wave signal, which is input from an outside, to the second planar lens.

Furthermore, the transmission device includes a beam splitter formed in the transmission path in a strip shape by a grid arrangement of a second hole array by using one of materials of a dielectric material, a semiconductor material, a conductor material and a magnetic material, or a combination of two or more of the materials, and configured to propagate, by reflection or transmission by a second refractive index set by a content rate of a gas by the second through-holes in a region of the strip shape, the terahertz-wave signal of the parallel waves, which is transmitted from the first planar lens, to the second planar lens, the beam splitter being formed as a single piece and integrated in the substrate, or being formed together with the transmission path in the substrate.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view illustrating a conceptual configuration example of a terahertz-wave system including a transmission device which transmits a terahertz-wave signal according to an embodiment.

FIG. 2 is a view illustrating a conceptual configuration of a transmission device with three ports.

FIG. 3 is a view illustrating a configuration example of a first port including a photonic crystal waveguide.

FIG. 4 is a view illustrating a configuration of a coupling portion between the photonic crystal waveguide and a planar lens unit.

FIG. 5 is a view illustrating a configuration of a first planar lens unit.

FIG. 6 is a conceptual view for explaining an arrangement of through-holes of the first planar lens unit.

FIG. 7 is a view illustrating an example of a path of a terahertz-wave signal passing through the through-holes.

FIG. 8A is a view conceptually illustrating a path of terahertz-wave signal which becomes parallel waves.

FIG. 8B is a view conceptually illustrating a path of a terahertz-wave signal which focuses.

FIG. 9 is a view conceptually illustrating a terahertz-wave signal spreading radially in a planar lens unit.

FIG. 10 is a view illustrating an arrangement example of through-holes which form a beam splitter unit.

FIG. 11 is a view for explaining an arrangement relationship of through-holes.

FIG. 12 is a view for explaining reflection and transmission of a terahertz-wave signal in the beam splitter unit.

FIG. 13 is a view illustrating characteristics of reflectance relative to the frequency of a terahertz-wave signal.

FIG. 14 is a view illustrating characteristics of reflectance relative to the frequency of a terahertz-wave signal.

FIG. 15 is a view illustrating a ratio between reflective waves and transmissive waves relative to the frequency of a terahertz-wave signal.

FIG. 16 is a view illustrating a ratio between reflective waves and transmissive waves relative to the frequency of a terahertz-wave signal.

FIG. 17 is a view illustrating a comparison between transmissive waves relative to the frequency of terahertz-wave signals.

FIG. 18 is a view illustrating a configuration example of a first port including a dielectric slot waveguide unit according to a second application example.

FIG. 19 is an enlarged view illustrating, in enlarged scale, a coupling portion between the dielectric slot waveguide unit and a planar lens unit.

FIG. 20 is a view illustrating characteristics of signal intensity of transmittance in a planar lens unit using a photonic crystal waveguide and a planar lens unit using a dielectric slot waveguide unit.

FIG. 21 is a view illustrating a relationship of reflectance and transmittance relative to an air content rate ζ by through-holes of a transmission path.

FIG. 22A is a view for describing a structure for fitting a beam splitter unit, which is formed as a separate piece, into a transmission device.

FIG. 22B is a view illustrating a structure in which the beam splitter unit shown in FIG. 22A is fitted in the transmission device.

FIG. 23A is a view for describing a structure for fitting a beam splitter unit, which is formed to have a hybrid stacked structure, into a transmission device.

FIG. 23B is a view illustrating a structure in which the beam splitter unit of the hybrid structure shown in FIG. 23A is fitted in the transmission device.

### DETAILED DESCRIPTION

Hereinafter, embodiments of the present invention will be described in detail with reference to the accompanying drawings.

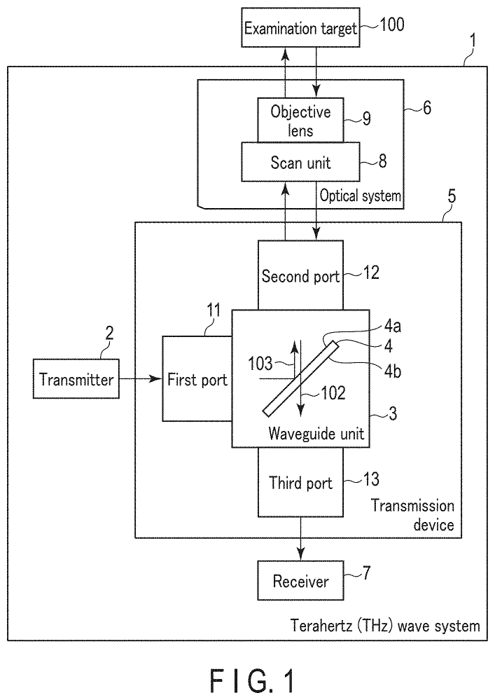

A terahertz-wave system including a transmission device according to an embodiment will be described. FIG. 1 is a view illustrating a conceptual configuration example of the terahertz-wave system including the transmission device which transmits a terahertz-wave signal according to the present embodiment. The terahertz-wave signal belongs to a frequency band ranging from a region of electromagnetic waves to a region light. Here, it is assumed that the terahertz-wave signal is electromagnetic waves with the frequency of about 100 GHz to 3 THz, or the wavelength of about 30 μm to 1 mm, but the terahertz-wave signal is not clearly defined. Depending on a target of use, or the like, the upper limit of the range of frequencies of terahertz waves may be set to 10 THz.

A terahertz-wave system 1 of the present embodiment includes a transmitter 2 which emits and outputs a terahertz-wave signal; a transmission device 5 which includes a waveguide unit 3 including a beam splitter unit 4, and constitutes transmission paths of the terahertz-wave signal and a reflective signal of the terahertz-wave signal; an optical system 6 which radiates the terahertz-wave signal emitted from the transmission device 5 onto an examination target 100, and which receives a reflective signal of the terahertz-wave signal reflected by the examination target 100; and a receiver 7 to which the reflective signal of the terahertz-wave signal is input through the transmission device 5, and which generates a detection signal based on the reflective signal.

The terahertz-wave system 1 can be applied to a wireless communication apparatus, an imaging apparatus, and others, by supplementing peripheral devices in accordance with purposes of use. In the wireless communication apparatus, for example, since the terahertz-wave signal can treat a large volume of information, the wireless communication apparatus can be used for multiplex broadcasting communications of high-quality images in an uncompressed form. In addition, in the case of the imaging apparatus, the imaging apparatus can be used for a security check in airports or the like, or for a nondestructive inspection for observing an inside from an outside. Furthermore, the presence/absence of rust, cracks, breakage, or the like can be detected in close proximity from surfaces of objects which cannot directly be viewed and are coated or covered with surface-coating components, such as coated pipes, coated walls, or coated cords.

The transmitter 2 includes an oscillator which emits a terahertz-wave signal, and in which, for example, a resonator is integrated in a negative-resistance element. In one configuration example, the transmitter 2 is constructed by a combination of a negative-resistance element, which is resonant tunneling diode (RTD), and a resonator which is a slot antenna. Alternatively, the transmitter 2 may be configured to include an RTD and a microstrip resonator. Circuit elements, such as an RTD, can be formed on a semiconductor substrate.

As the receiver 7, use can be made of a well-known structure, such as a diode (Schottky barrier diode or the like) in a direct detection method, which is usable in an environment at normal temperatures, or a bolometer, or a heterodyne detector, or the like. Another example of the receiver is a quantum detector which is usable under an environment at very low temperatures. Note that when the transmission device is used in a terahertz-wave system which constitutes an inspection apparatus or the like, the receiver 7 is connected to a processing apparatus such as a personal computer (not shown), and judgment based on a preset criterion or various processes are executed for a detection signal that is detected. Further, by providing the system with an interface function, the system can communicate with a server via a network such as the Internet, and can transmit detected data. Thereby, data processing and data analysis can be performed at a place different from the place where an inspection is performed.

The optical system 6 includes a scan unit 8 and an objective lens 9. The scan unit 8 scans the terahertz-wave signal, which is sent from the transmission device 5, by a swinging galvanomirror or a rotating polygon mirror, and converts the terahertz-wave signal to a scan signal. The objective lens 9 focuses and radiates the scan signal on an examination target, and receives a reflective signal from the examination target. In the present embodiment, by way of example, a mono-static structure is described in which transmission and reception are performed by one component such as the objective lens 9 or an antenna, but the embodiment is not limited to this. For example, bi-static structure may be adopted which is constructed by a component which radiates (or emits) the scan signal, and a component which receives light of (or receives) the reflective signal from the irradiated target. For example, in the case of radiating a terahertz-wave signal on some target, when the direction of incidence of the terahertz-wave signal on the target is different from the direction of reflection of the reflective signal of the terahertz-wave signal reflected by the target, elements such as the objective lens 9 or antenna are individually disposed. Note that the scan unit 8 is a structural part which is provided in accordance with the purpose of use, or device specifications, of the terahertz-wave system 1, and the scan unit 8 is not always indispensable.

The substrate, which is a base component of the transmission device 5, is formed by using a semiconductor substrate of, for example, silicon (Si), indium phosphide (InP), gallium arsenide (GaAs), or gallium nitride (GaN) in the present embodiment, the semiconductor substrate is used in the form of not a conductor but a dielectric. The material of the substrate is not limited to these materials, and other materials can similarly be used if the electrical characteristics of materials have the same dielectric properties as the substrate used in the present embodiment. Hereinafter, a description will be given of an example in which a silicon semiconductor substrate is used as the substrate the transmission device 5 of the embodiment.

In the example described below, the transmission device 5 is a 3-port-type transmission device including the waveguide unit (planar silicon slab) 3, a signal supply port (first port) 11, a signal transmission/reception port (second port) 12 and a reflective wave signal reception port (third port) 13, which are integrally formed from a single silicon semiconductor substrate. In addition, the beam splitter unit 4 is formed together with the waveguide unit 3 on the silicon semiconductor substrate, or, as will be described later, is formed separately from the silicon semiconductor substrate and then fitted in the waveguide unit 3 and constructed integral with the silicon semiconductor substrate.

In addition, in the waveguide unit 3 in this embodiment, a doping process is performed on a part of a side opposed to the first port 11, where no port is provided, and this part is provided with a function of an absorber of a terahertz-wave signal that has passed through the beam splitter unit 4. This absorber function extinguishes a reflective signal of the terahertz-wave signal which passes through the beam splitter unit 4, is reflected by an end portion of the waveguide unit 3 and returns to the beam splitter unit 4. Besides, the reflective signal can also be suppressed by keeping open that part of the waveguide unit 3, which is opposed to the first port 11.

Alternatively, a fourth port (not shown), which is a new port, may be provided on the above-described side opposed to the first port 11, and a terahertz-wave signal that is output may be used for some other system or function. The transmission device 5 can utilize the fourth port, for example, for a system which monitors a propagated terahertz-wave signal, and further for a function of intentionally generating an interference signal of a terahertz-wave signal which returns to the beam splitter unit 4.

In the description below, the term “slab” means a semiconductor or a semiconductor thin film, which has a parallel-plate shape. In addition, a slab mode means a state (mode) of an electromagnetic field in which, with a slab functioning as a core, and with upper air and lower air functioning as a clad, a terahertz-wave signal propagates in the state in which the terahertz-wave signal is confined in the core. Note that, as regards the slab mode in the present embodiment, since a confining mechanism is not provided in the slab, the slab mode means a mode in which, as illustrated in FIG. 9, the terahertz-wave signal spreads, like spatial propagation, in a semicircular shape or an arcuate shape in the plane of the planar silicon slab that is the waveguide unit 3, and then propagates in the slab like planar waves (parallel waves).

The planar silicon slab of the waveguide unit 3 is set based on the frequency (wavelength) of a terahertz-wave signal that is used. In the present embodiment, for example, if the frequency is 330 GHz (0.33 THz), a silicon semiconductor substrate with a thickness of 200 μm is used. The waveguide unit 3 in the present embodiment has a rectangular outer shape, and has a rectangular cross-sectional shape between both major surfaces which are opposed in parallel.

As will be described later, the waveguide unit 3 transmits a terahertz-wave signal, which is deflected to parallel waves (collimation) by a first planar lens unit 22 and a second planar lens unit 32, in the state in which the terahertz-wave signal is confined in the silicon substrate. In the present embodiment, a terahertz-wave signal, which is transmitted in the confined state in the silicon substrate of the waveguide unit 3, is referred to as “slab mode beam”.

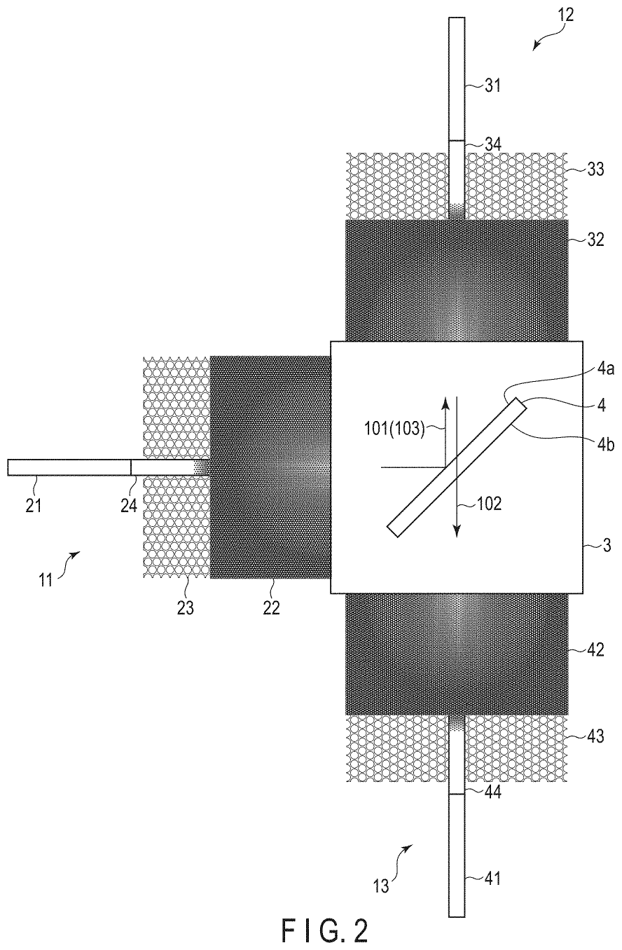

FIG. 2 is a view illustrating a conceptual configuration of the transmission device 5 which is provided with three ports using photonic crystal waveguides. As illustrated in FIG. 2, the first to third ports 11, 12 and 13 of the present embodiment are disposed on sides of the rectangular waveguide unit 3 in accordance with the setting of transmission paths utilizing transmission and reflection of the terahertz-wave signal by the beam splitter unit 4. The transmission paths of the terahertz-wave signal in the present embodiment are set to be an emission path 103 through which a terahertz-wave signal (emission signal), which enters the first port 11 from the transmitter 2, is reflected by the beam splitter unit 4 and propagated to the second port 12, and an incidence path 102 through which a reflective wave signal (detection signal) of the terahertz-wave signal, which is reflected by the examination target and enters the second port, is passed through the beam splitter unit 4 and propagated to the third port 13. Specifically, the path of the terahertz-wave signal can be changed as appropriate by the method of utilizing the transmission and reflection of the terahertz-wave signal by the beam splitter unit 4.

### FIRST APPLICATION EXAMPLE

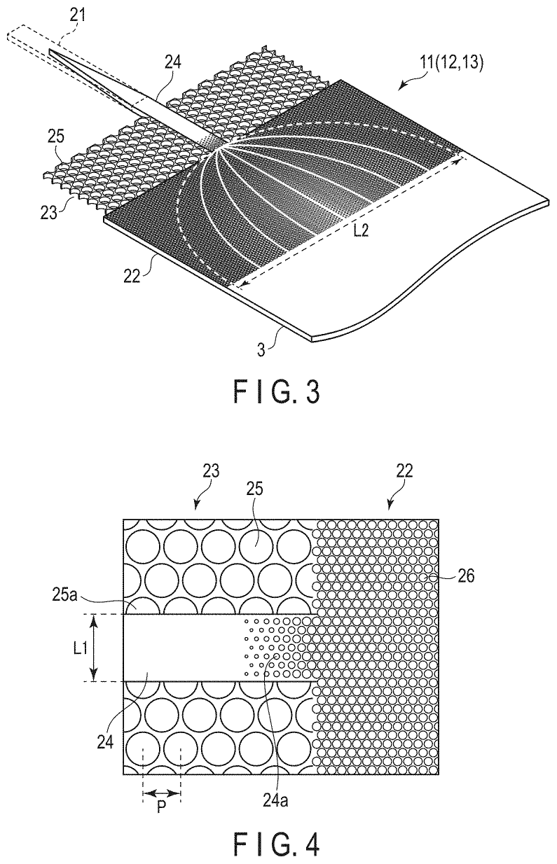

Referring to FIG. 2 and FIG. 3, a description will be given of a first application example in which photonic crystal waveguides are used in the first to third ports 11, 12 and 13. FIG. 3 is a view illustrating a configuration example of the first port including a photonic crystal waveguide.

The first to third ports 11, 12 and 13 are formed on sides of the rectangular waveguide unit 3 such that the first to third ports 11, 12 and 13 are integral with the waveguide unit 3. Note that the other side corresponding to the fourth port is provided with the above-described absorber of the terahertz-wave signal, and the absorber absorbs a terahertz-wave signal leaking from the beam splitter unit 4 (to be described later), and prevents the occurrence of a reflective signal. The first to third ports 11, 12 and 13 are configured to include planar lens units, and first to third waveguides 24, 34 and 44, respectively. First, second and third metallic waveguide tubes 21, 31 and 41 are fitted on, and coupled to, the first to third waveguides 24, 34 and 44, respectively. This coupling may be fixation using an adhesive or welding material.

Specifically, the first port (signal supply port) 11 includes the first planar lens unit 22, and a first photonic crystal waveguide 23, and supplies (inputs) the terahertz-wave signal, which is transmitted from the transmitter 2 through the first metallic waveguide tube 21, to the waveguide unit 3.

The second port (signal transmission/reception port) 12 includes the second planar lens unit 32, and a second photonic crystal waveguide 33. The second port 12 outputs the terahertz-wave signal, which is propagated through the waveguide unit 3, to the optical system 6 through the second metallic waveguide tube 31, receives a reflective wave signal (detection signal) of the terahertz-wave signal which is reflected by the examination target 100 (not shown) and returned from the optical system 6, and propagates the reflective wave signal to the waveguide unit 3.

The third port (reflective wave signal reception port) 13 includes the third planar lens unit 32, and a third photonic crystal waveguide 43, and outputs the reflective wave signal, which is propagated through the waveguide unit 3, to the receiver 7 through the third metallic waveguide tube 41.

To begin with, the first to third metallic waveguide tubes 21, 31 and 41 will be described.

The first metallic waveguide tube 21, second metallic waveguide tube 31 and third metallic waveguide tube 41 are hollow waveguides with equal rectangular cross-sectional shapes. The cross-sectional shape of the waveguide tube is not limited to a rectangular shape, and may be a circular shape, for example, an elliptic shape. In the respective waveguide tubes, the first metallic waveguide tube 21 has one end connected to the transmitter 2 and the other end coupled to the first photonic crystal waveguide 23, and supplies the terahertz-wave signal, which is transmitted from the transmitter 2, to the first photonic crystal waveguide 23.

The second metallic waveguide tube 31 has one end connected to the optical system 6 and the other end coupled to the second photonic crystal waveguide 33. The second metallic waveguide tube 31 propagates the terahertz-wave signal, which is propagated from the second photonic crystal waveguide 33, to the optical system 6, and propagates a reflective signal of the terahertz-wave signal, which is reflected by the examination target 100 (FIG. 1) and returned from the optical system 6, to the second photonic crystal waveguide 33.

The third metallic waveguide tube 41 has one end connected to the receiver 7 and the other end coupled to the third photonic crystal waveguide 43, and outputs the terahertz-wave signal, which is propagated from the third photonic crystal waveguide 43 through the waveguide unit 3, to the receiver 7.

The first to third metallic waveguide tubes 21, 31 and 41 are rectangular waveguides which are formed hollow with a rectangular cross section, by using a metallic material such as aluminum or copper. The metallic waveguide tubes are engaged with, and coupled to, tip-end waveguides (taper spikes) each provided in a manner to project in a taper shape with a rectangular cross section from a terminal end of each terahertz-wave transmission path of the first to third waveguides 24, 34 and 44 (to be described later).

Next, referring to FIG. 3 and FIG. 4, the first to third photonic crystal waveguides 23, 33 and 34 will be described. FIG. 4 is a view illustrating a configuration of a coupling portion between the photonic crystal waveguide and the planar lens unit. The first to third photonic crystal waveguides 23, 33 and 34 are input/output interfaces of terahertz-wave signals using two-dimensional photonic crystal slabs, and first to third waveguides 24, 34 and 44, which are solid and linearly extend toward the waveguide unit 3, are disposed at central portions of the first to third photonic crystal waveguides 23, 33 and 34. Note that the first to third photonic crystal waveguides 23, 33 and 43 have identical configurations, and, hereinafter, the first photonic crystal waveguide 23 will representatively be described by way of example.

In the first photonic crystal waveguide 23, the first waveguide 24 With a linear shape is formed on a silicon semiconductor substrate with a thickness of, for example, 200 μm, and a planar lens unit formed of through-holes (third through-hole) 25 is formed on both sides of the first waveguide 24. In the planar lens unit, many through-holes 25 are formed in an array on both sides of the first waveguide 24 by using a lithography technology and an anisotropic etching technology (e.g. plasma etching), which are used as semiconductor fabrication technologies. The through-holes 25 are opened in a manner to form such a staggering disposition (triangular grid arrangement) that the through-holes 25 are displaced by a ½ pitch from column to column, and mutually neighboring through-holes 25 constitute a positional relationship of a regular triangle.

In the structure in which the through-holes 25 are formed on both sides of the solid first waveguide 24, the terahertz-wave signal stays in the first waveguide 24 such that the terahertz-wave signal does not leak, by a photonic bandgap effect by the through-holes 25. In addition, when upper and lower surfaces of the first waveguide 24 are exposed to atmospheric air, total reflection occurs by a difference in refractive index between silicon and air, and the terahertz-wave signal similarly stays in the first waveguide 24. Thus, since the terahertz-wave signal is propagated in the confined state in the first waveguide 24, the first waveguide 24 functions as a transmission path.

In the coupling portion between the first waveguide 24 and first planar lens unit 22, through-holes (fourth through-holes) 24a are formed on the first waveguide 24 side in a staggering disposition, the through-holes 24a having diameters which gradually increase from the first waveguide 24 toward the first planar lens unit 22. The through-holes 24a make impedance matching between the first waveguide 24 and the first planar lens unit 22, and prevent the occurrence of reflective waves of the terahertz-wave signal which is electromagnetic waves. By providing the coupling portion, the bandwidth can be made wider than one octave. The diameters of the through-holes 24a formed in the coupling portion are less than the diameters of through-holes 26 (to be described later) formed in the first planar lens unit 22.

In addition, as illustrated in FIG. 4, the through-holes 25, which are in contact with the first waveguide 24, are formed such that the conical surface (cut surface) side located on the center axis of the semicylindrical shape comes in contact with the first waveguide 24. The first waveguide 24 and through-holes 25 of the first photonic crystal waveguide 23 are formed at the same time as through-holes 26 (to be described later) of the first planar lens unit 22.

The first waveguide 24 is formed as a reflecting mirror which reflects the terahertz-wave signal at cycles of an approximately half-wave length, and functions as a waveguide. Thus, the dimension of the cross section of the first waveguide 24 (mainly, the width of the waveguide) is set by the frequency (wavelength) of the terahertz-wave signal that propagates. In the present embodiment, for example, when the frequency of the terahertz-wave signal is 0.33 THz (330 GHz), a width L1 of the waveguide is set at 459.7 μm, a radius r of the through-hole 25 is set at 137.8 μm, and a pitch (distance between centers of mutually neighboring through-holes) P is set at 336 μm in a regular-triangular equilateral grid arrangement. Needless to say, these numerical values are merely examples, and the numerical values are not limited.

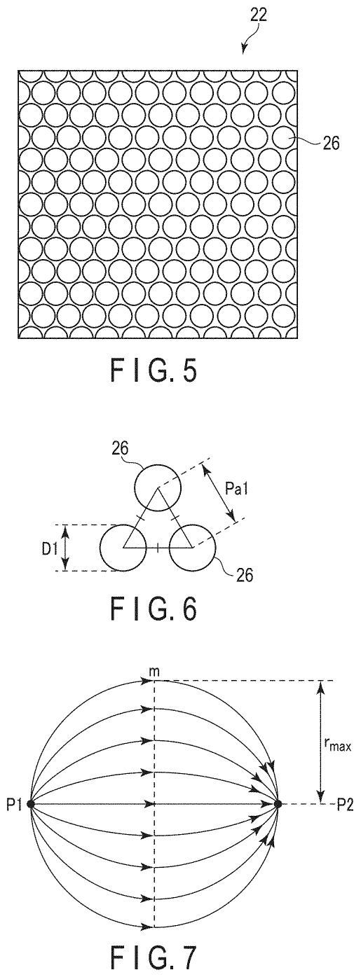

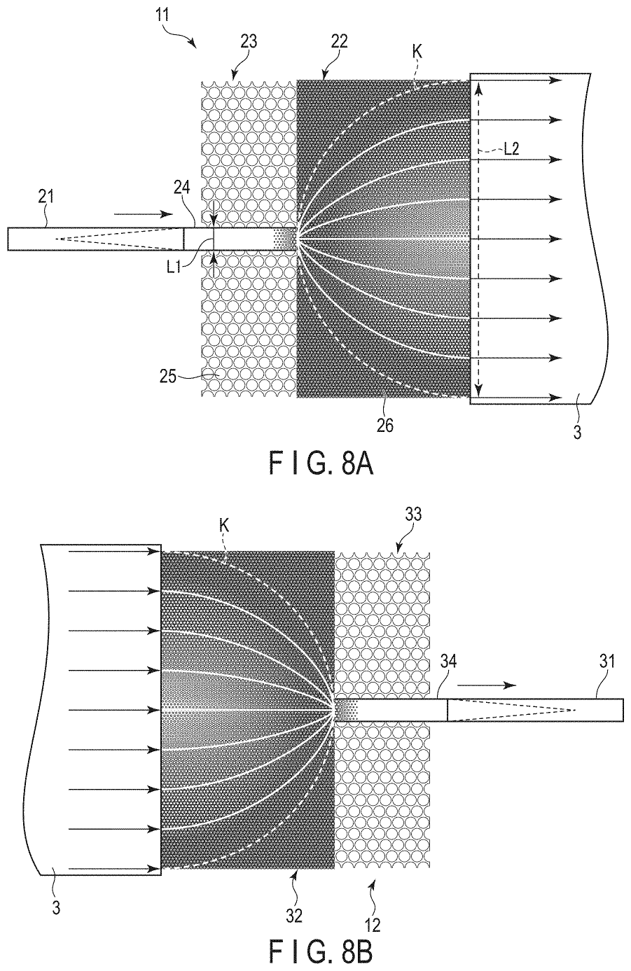

Next, the first to third planar lens units 22, 32 and 42 will be described with reference to FIG. 2, FIG. 3, and FIG. 5 to FIG. 9. FIG. 5 is a view illustrating through-holes which are formed in the first planar lens unit 22 and have a lens function. FIG. 6 is a conceptual view for explaining an arrangement of through-holes of the first planar lens unit 22. FIG. 7 is a view illustrating an example of a path of a terahertz-wave signal passing through through-holes. FIG. 8A is a view conceptually illustrating a path of a terahertz-wave signal which passes through the first port and becomes parallel waves. FIG. 8B is a view conceptually illustrating a path of a terahertz-wave signal which passes through the second port and focuses. FIG. 9 is a view conceptually illustrating, as virtual waves, the amplitude of a terahertz-wave signal spreading radially in the planar lens unit.

The first planar lens unit 22, second planar lens unit 32 and third planar lens unit 42 are identical planar lenses, and are, for example, semicircular convex terahertz lenses which can perform both the generation of parallel waves (collimation) by diverging the terahertz-wave signal, and the convergence (focusing) of the terahertz-wave signal. In the present embodiment, it is assumed that the first, second and third planar lens units 22, 32 and 42 have the same structure and the same capability, and the first planar lens unit 22 will representatively be described by way of example. In the present embodiment, the first, second and third planar lens units 22, 32 and 42 are described as having the same capability by way of example. However, needless to say, the embodiment is not limited to this, and the hole diameters and inter-hole distances of the through-holes which form lenses (to be described later) can be changed depending on the purposes of use and specifications.

The first planar lens unit 22 is formed at the same time as the first photonic crystal waveguide 23 by using the above-described semiconductor fabrication technology. As illustrated in FIG. 5 and FIG. 6, in the first planar lens unit 22, through-holes 26 are formed in an array of a plurality of columns in a manner to come in contact with one side of the rectangular first photonic crystal waveguide 23. The through-holes 26 are displaced by a ½ pitch from column to column, and, as illustrated in FIG. 6, mutually neighboring through-holes 26 form a staggering arrangement that constitutes a positional relationship of a regular triangle, with an identical distance Pal between the through-holes. Each through-hole is filled with a gas, for example, air in the atmosphere.

The first planar lens unit 22 is a lens which is derived from a Maxwell fisheye lens, and can engineeringly adjust the refractive index, for example, like a GRIN lens (Gradient Index lens), in a terahertz range of electromagnetic waves. Specifically, the first planar lens unit 22 can engineeringly adjust the refractive index by adjusting the hole diameter and the inter-hole distance in the form of the periodic staggering arrangement (triangular grid arrangement) of through-holes, and the first planar lens unit 22 can easily be applied to planar lenses. Here, the Maxwell fisheye lens that is applied to the first planar lens unit 22 is an optical component which maps a point light source (input point) P1 to a diametrically opposed focal point (output point) P2, as indicated by loci of a light flux shown in FIG. 7, by adjusting the refractive index, and through which the light flux pass in such a manner as to radially diffuse and focus in the lens. Both of the point light source and the focal point are situated on the same circumference. When a plurality of point light sources are input from different positions, focal points occur at positions on the circumference, respectively, the positions being opposed to the point light sources through the center.

If the refractive index distribution is designed according to equation (1) below, the light flux draws the loci illustrated in FIG. 7. Specifically, the light flux that passes through the lens becomes parallel waves, which are parallel to the incidence direction of the point light source P1, at a dotted line m shown in FIG. 7, which perpendicularly passes through the lens center.

Accordingly, by cutting the circular Maxwell fisheye lens into semicircular portions by the perpendicular m to the incidence direction, it becomes possible to diffuse one point light source in a semicircular or arcuate shape and to convert the diffused light to a parallel beam, as illustrated in FIG. 7 and FIG. 8A. In addition, as illustrated in FIG. 7 and FIG. 8B, if a parallel beam is made incident on a planar surface side of the semicircle of the Maxwell fisheye lens, the parallel beam can be converged in an arcuate shape and converted (focused) at one point light source. Besides, assuming that a maximum refractive index is set in the state in which no through-hole is provided in the silicon semiconductor substrate, the diameter (size) of the through-hole may be changed, and thereby a freely selected refractive index (effective refractive index medium) n(r) can be acquired in a range of 1 to nₘₐₓ, as expressed by equation (1). It should be noted, however, that, in order to acquire this refractive index, the size (hole diameter) of the hole is set to ¼ or less of the wavelength. In the present embodiment, semicircular Maxwell fisheye lens (or called “half-Maxwell fisheye lens”) is used for a terahertz wave signal of electromagnetic waves.

$$n ( r ) = \frac{{n}_{max}}{1 + {( \frac{r}{{r}_{max}} )}^{2}} \qquad ( 1 )$$

where nₘₐₓ is a maximum refractive index inside the lens, rₘₐₓ is a maximum radius of the lens, r is a radial position inside the lens, a is an inter-center distance between mutually neighboring through-holes, and D1 is a diameter of the through-hole. Accordingly, firstly, the refractive x is essentially a free parameter, which may be chosen at the convenience of the designer. Secondly, the maximum value of the refractive index occurs at a diametric position (r=0) passing through the center of the lens. Thirdly, since n(rₘₐₓ)=nₘₐₓ/2, the refractive index of the effective medium, which is used to realize a given Maxwell fisheye lens, varies continuously over a two-to-one ratio.

From the above, in the first planar lens unit 22, like the GRIN lens, the maximum refractive index is a freely selectable parameter, and can selectively be set according to the design of the apparatus. Specifically, the refractive index can be engineeringly adjusted by the size (hole diameter) of the through-hole and the form of the periodic grid (pitch or inter-hole distance), i.e. the arrangement of the staggering pattern as in the present embodiment. The width of the first planar lens unit 22 (the distance between the first photonic crystal waveguide 23 and the waveguide unit 3) is set to a length according to the diameter of the lens that is formed.

Next, referring to FIG. 7 to FIG. 9, a description will be given of generation (“collimate”) of parallel waves by radiation of a terahertz-wave signal which is input to the first port 11 using the photonic crystal waveguide.

The terahertz-wave signal emitted from the above-described transmitter 2 shown in FIG. 1 propagates in the metallic waveguide tube 21 and is transmitted to the first waveguide 24. Since the first waveguide 24 localizes the terahertz-wave signal that is a three-dimensional beam near the focal point, the terahertz-wave signal is propagated in the confined state in the field of the narrow first waveguide 24 and is made incident on the first planar lens unit 22.

As illustrated in FIG. 8A, the first planar lens unit 22 refracts the terahertz-wave signal, which is made incident from the first waveguide 24 as parallel waves with a width L1, according to the refractive index (effective refractive index) set by the above-described hole diameter of through-hole and the inter-hole distance, and passes the refracted terahertz-wave signal in a manner to radially diffuse along an ark K. The first planar lens unit 22 transmits the terahertz-wave signal from the first waveguide 24 to the waveguide unit 3 as parallel waves with a width L2 (L2>L1) The waveguide unit 3 propagates the terahertz-wave signal in the state of the parallel waves.

In addition, the terahertz-wave signal of the parallel waves, which propagates in the waveguide unit 3, is made incident on the second planar lens unit 32. The second planar lens unit 32 refracts the incident terahertz-wave signal of the parallel waves according to the set refractive index (effective refractive index), focuses the terahertz-wave signal at one point along the arc K, and inputs the terahertz-wave signal to the second waveguide 34 of the second photonic crystal waveguide 33. The second waveguide 34 propagates the input terahertz-wave signal to the coupled metallic waveguide tube 311, and outputs the terahertz-wave signal to the optical system 6 shown in FIG. 1.

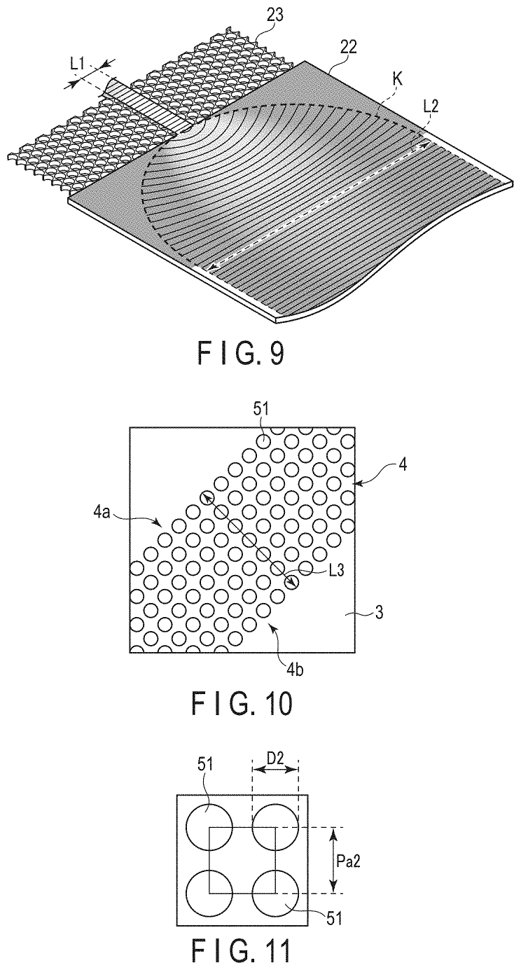

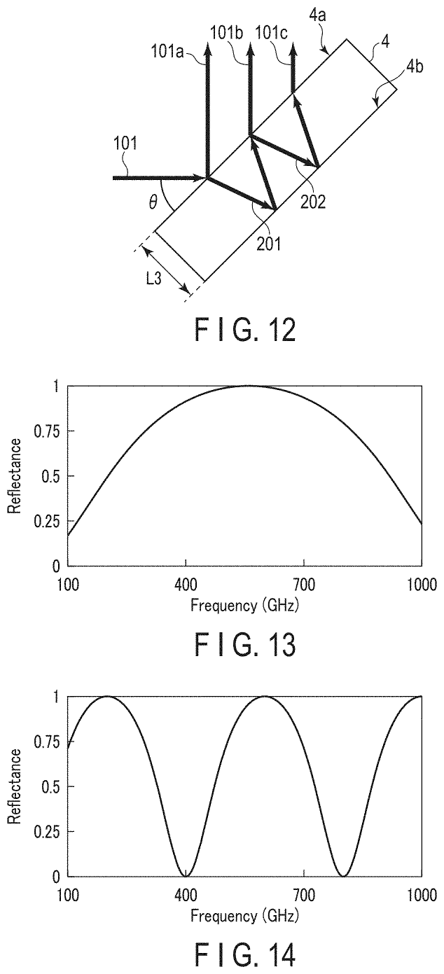

Next, referring to FIG. 10 to FIG. 12, the beam splitter unit 4 formed in the waveguide unit 3 will be described. FIG. 10 is a view illustrating an arrangement example of through-holes which form the beam splitter unit 4. FIG. 11 is a view for explaining an arrangement relationship of the through-holes. FIG. 12 is a view for explaining reflection and transmission of a terahertz-wave signal in the beam splitter unit.

The beam splitter unit 4 is formed with a freely selected width L3 by arraying many through-holes 51 in a grid shape in the waveguide unit 3. The through-holes 51 are formed at the same time as the through-holes of the first to third planar lens units 22, 32 and 42 and first to third photonic crystal waveguides 23, 33 and 43 of the respective ports by using the above-described semiconductor fabrication technology.

As illustrated in FIG. 10 and FIG. 11, the beam splitter unit 4 is formed in a stripe shape by a grid arrangement in which mutually neighboring through-holes 51 are spaced apart with a pitch of an equal distance Pa2 in vertical and horizontal directions. Each through-hole 51 is filled with a gas, for example, air in the atmosphere. The content rate of a gas, for example, the content rate ζ of air (hereinafter referred to as “air content rate ζ”), by the through-holes 51 of the beam splitter unit 4 in the grid arrangement shown in FIG. 10 influences the reflection and transmission of the terahertz-wave signal. The air content rate ζ indicates the ratio of air (space) occupied in that region of the silicon semiconductor substrate, where the beam splitter unit is formed at the time when many through-holes are disposed in the grid arrangement. As illustrated in FIG. 21, as regards the ratio (or proportion) between the reflection and transmission of the terahertz-wave signal, if the air content rate ζ is increased by increasing the diameter of the through-hole 51, the reflectance increases but the transmittance decreases, and thus the ratio between the reflection and transmission has a relation of inverse proportion with opposite linear-function gradients. For example, when the air content rate ζ is set at 0.2, approximately 83% of the terahertz-wave signal in the beam splitter unit 4 is transmitted, and the other 17% of the terahertz-wave signal is reflected. In addition, when the air content rate ζ is set at 0.4, both the transmission and the reflection of the terahertz-wave signal in the beam splitter unit 4 are 50%, and the beam splitter unit 4 functions as a half mirror. Based on a diameter 132 of the through-hole 51 and the distance of the pitch Pa2, the air content rate can be calculated by the following equation (2).

$$ζ ( Air content rate ) = \frac{Area occupied by air}{Area of unit cel} = \frac{{π ( \frac{D 2}{2} )}^{2} \times \frac{1}{4} \times 4}{P a {2}^{2}} = \frac{π D {2}^{2}}{4 P a {2}^{2}} \qquad ( 2 )$$

In the present embodiment, many through-holes 51 are used as the beam splitter unit 4 which functions as the half-mirror.

As illustrated in the above-described FIG. 2, the beam splitter unit 4 is disposed in the waveguide unit 3 with an inclination to the first to third ports 11, 12 and 13 in a manner to form the emission path 103 and incidence path 102 which are transmission paths of the terahertz-wave signal. Specifically, the beam splitter unit 4 reflects the terahertz-wave signal (emission signal) which enters the first port 11 from the transmitter 2, and propagates the terahertz-wave signal to the second port 12. In addition, the beam splitter unit 4 transmits the reflective wave signal (detection signal) of the terahertz-wave signal which is reflected by the examination target and enters the second port, and propagates the reflective wave signal to the third port 13. Note that the number of through-holes 51 formed along the width L3 of the beam splitter unit 4 shown in FIG. 10 is merely an example, and the number is not limited.

Next, the reflection and transmission of the terahertz-wave signal in the beam splitter unit 4 will be described.

The beam splitter unit 4 utilizes two side surfaces of the stripe as reflecting surfaces. Thus, when the width (thickness) of he beam splitter unit is set, it is necessary to consider the influence of Fabry-Perot interference.

As illustrated in FIG. 10 and FIG. 12, she beam splitter unit 4 includes two reflecting surfaces, namely a first reflecting Surface (or first side surface) 4a corresponding to a front surface of the beam splitter unit 4, and a second reflecting surface (or second side surface) 4b corresponding to an internal bottom surface of the beam splitter unit 4. The terahertz-wave signal that is incident on the beam splitter unit 4 is reflected by the first reflecting surface 4a. However, since the beam splitter unit 4 includes the two opposed reflecting surfaces 4a and 4b, part of the incident terahertz-wave signal passes into the inside of the beam splitter unit 4 and is confined in the beam splitter unit 4, and Fabry-Perot interference occurs which performs multiple internal reflection between the first reflecting surface 4a and second reflecting surface 4b.

Specifically, a loss occurs in the reflective signal of the terahertz-wave signal entering the beam splitter unit 4. The transmission in this case depends on the wavelength of the terahertz-wave signal. The wavelength dependency in this transmission occurs by the interference between light components which are multiply reflected between the two reflecting surfaces. if the phases of the terahertz-wave signals agree, such interference as to strengthen the transmissive light occurs, and a peak of transmittance occurs. Conversely, if the phases of the terahertz-wave signals are opposite to each other, such interference as to weaken the transmissive light occurs, and a trough of transmittance occurs. Whether the phases of multiple reflective signals agree or not is determined by the wavelength (λ) of the terahertz-wave signal, the angle (θ) of the terahertz-wave signal passing through the beam splitter unit 4, the width L3 of the beam splitter unit 4, and the refractive index (n) of the semiconductor substrate. Here, if it is assumed that the width (the width of the column, or thickness) of the beam splitter unit 4 is L3, a reflectance R(δ) of the beam splitter unit 4, and a phase difference (or polarization angle) δ(f) are calculated by the following equations (3) and (4).

$$\begin{matrix}R ( δ ) = \frac{4 r {sin}^{2} ( \frac{δ}{2} )}{{( 1 - {r}^{2} )}^{2} + 4 r {sin}^{2} ( \frac{δ}{2} )} & ( 3 ) \\ δ ( f ) = \frac{4 π L 3}{c} f \sqrt{n - sin θ} & ( 4 )\end{matrix}$$

where n is a refractive index, r is a reflectance, and θ is an incidence angle to the beam splitter unit 4.

As illustrated in FIG. 12, if a terahertz-wave signal 101, which is emitted from the first port 11 to the beam splitter unit 4, is incident on the beam splitter unit 4, a first reflective signal 101a is reflected by the first reflecting surface 4a by first reflection at a reflection angle corresponding to the incidence angle θ.

In addition, part of the incident terahertz-wave signal passes into the inside of the beam splitter unit 4, and reflects multiple times between the two reflecting surfaces 4a and 4b, i.e. undergoes multiple reflection. At the time of the multiple reflection, if the phase of the terahertz-wave signal coincides with the width L3 of the beam splitter unit 4, the terahertz-wave signal is emitted, at the time of reflection, from the first reflecting surface 4a as a secondary reflective signal 101b and a tertiary reflective signal 101c in the same direction as the first reflective signal 101a.

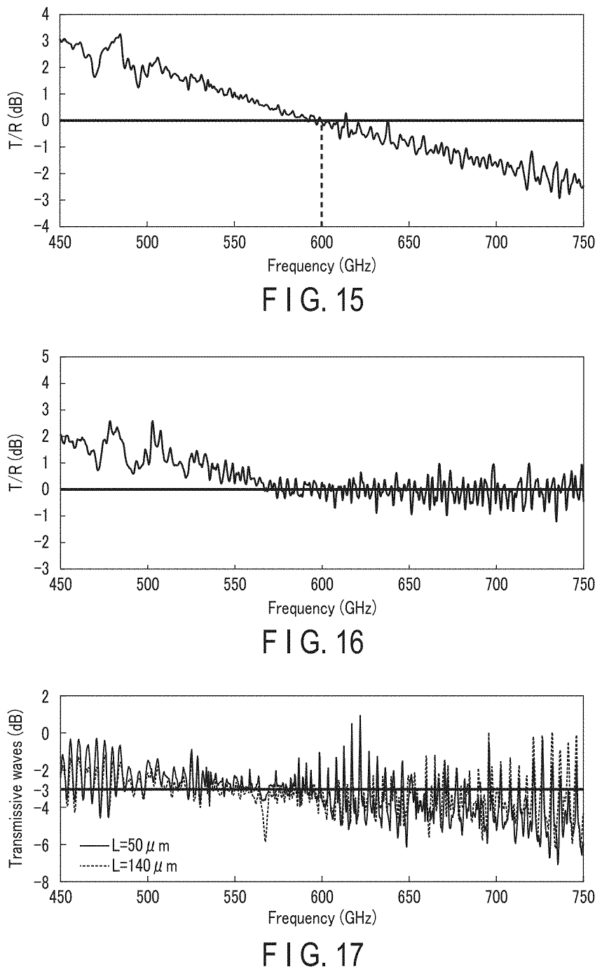

Referring to FIG. 13 to FIG. 17, a description will be given of the reflectance relative to the frequency of the terahertz-wave signal in the beam splitter unit 4 of the present embodiment. FIG. 13 is a view illustrating characteristics of reflectance relative to the frequency of a terahertz-wave signal at a time when the width L3 of the beam splitter unit 4 is set at 50 μm. FIG. 14 is a view illustrating characteristics of reflectance relative to the frequency of a terahertz-wave signal at a time when the width L3 of the beam splitter unit 4 is set at 140 μm. FIG. 15 is a view illustrating a ratio (T/R) between reflective waves (R) and transmissive waves (T) relative to the frequency of a terahertz-wave signal at a time when the width L3 of the beam splitter unit 4 is set at 50 μm. FIG. 16 is a view illustrating a ratio (T/R) between reflective waves (R) and transmissive waves (T) relative to the frequency of a terahertz-wave signal at a time when the width L3 of the beam splitter unit 4 is set at 140 μm. FIG. 17 is a view illustrating a comparison of transmissive waves (dB) relative to the frequency of terahertz-wave signals at a time when the width L3 of the beam splitter unit 4 is set at 50 μm and 140 μm.

In the present embodiment, if the reflectance relative to the frequency of a terahertz-wave signal at a time when the width L3 of the beam splitter unit 4 is set at 50 μm is calculated, the reflectance=1 when the frequency of the terahertz-wave signal is 500 GHz to 600 GHz, as illustrated in FIG. 13. Specifically, the loss of the terahertz-wave signal is decreased, and the terahertz-wave signal is substantially total-reflected in the beam splitter unit 4.

Here, assume the case in which the terahertz-wave signal (R) is made incident from the first port 11 and reflected by the beam splitter unit 4 while being propagated through the emission path 103, and the terahertz-wave reflective signal (T) is made incident from the second portion 12 and passed through the beam splitter unit 4 while being propagated through the incidence path 102. In this case, as illustrated in FIG. 15, as the frequency become higher, the gain of the ratio (T/R) decreases and depends on the frequency. In FIG. 15, the gain is highest at the ratio T/R=0 (dB), and the ratio between the transmissive waves and the reflective waves is 1:1.

Similarly, in the present embodiment, if the reflectance relative to the frequency of a terahertz-wave signal at, a time when the width L3 of the beam splitter unit 4 is set at 140 μm is calculated, the reflectance has such characteristics that a plurality of maximum values and a plurality of minimum values occur, as illustrated in FIG. 14. As regards the reflectance, for example, the reflectance=0 when the frequency of the terahertz-wave signal is 400 GHz, and the reflectance=1 when the frequency of the terahertz-wave signal is 600 GHz. Specifically, the terahertz-wave signal with the frequency of 400 GHz passes through the beam splitter unit 4, and the terahertz-wave signal with the frequency of 600 GHz is total-reflected by the beam splitter unit 4.

Besides, as illustrated in FIG. 16, the ratio (T/R) between the reflective waves (R) and transmissive waves (T) relative to the frequency of the terahertz-wave signal at a time when the width L3 of the beam splitter unit 4 is set at 140 μm becomes the ratio T/R=0 (dB) with respect to frequencies higher than about 570 GHz, and the ratio between the transmissive waves and the reflective waves keeps the state of 1:1. Specifically, when the width L3 of the beam splitter unit 4 is set at 140 μm, the dependency on frequency of the terahertz-wave signal becomes lower than when the width L3 of the beat splitter unit 4 is set at 50 μm, and stabler propagation can be performed.

Furthermore, as illustrated in FIG. 17, as regards the comparison between the transmissive waves at the time when the width L3 of the beam splitter unit 4 is set at 50 μm and the transmissive waves at the time when the width L3 of the beam splitter unit 4 is set at 140 μm, the beam splitter unit 4 in which the width L3 is set at 140 μm has lower dependency on the frequency of the terahertz-wave signal. Accordingly, as the frequency of the terahertz-wave signal becomes higher, the beam splitter unit 4 with the greater width L3 becomes easier to use.

From the above, when the frequency (or wavelength) of the terahertz-wave signal that is used was determined, the beam splitter unit 4 can adjust the reflectance of the terahertz-wave signal by adjusting the width L3 of the beam splitter unit 4, and can set the degrees of reflection and transmission. Conversely, when the width of the beam splitter unit 4 was determined, the beam splitter unit 4 can adjust the reflectance of the terahertz-wave signal by varying, as appropriate, the frequency (or wavelength) of the terahertz-wave signal, and can select the reflection and the transmission.

The transmission device 5 using the photonic crystal waveguide in the first application example of the present embodiment has the structure in which spatial optical molding components, such as lenses and a beam splitter, are integrated on one semiconductor substrate, can realize reduction in size and weight, and can easily be mounted in various apparatuses. Further, in the transmission device 5, since the positions of the spatial optical molding components are uniquely set relative to the semiconductor substrate, the transmission device 5 can be used without adjusting the positions of the respective spatial optical molding components as in the conventional art. Furthermore, individual mounts or holders for disposing the spatial optical molding components are not needed.

The waveguide unit 3, the first to third planar lens units 22, 32 and 42 of the ports 11, 12 and 13, the beam splitter unit 4, and the photonic crystal waveguides 23, 33 and 43, which constitute the transmission device 5, can be integrally formed batchwise by using lithography (exposure technology) and anisotropic etching technology, which relate to semiconductor device fabrication technology.

The first to third planar lens units 22, 32 and 42 of the transmission device 5 are composed of through-holes which are arranged in an array and have functions of planar-integration-type Maxwell fisheye lenses, convert the electromagnetic waves of the terahertz-wave signal, which is confined in the first waveguide 24 and propagated, into a planar-wave-like slab mode, and can change the direction of propagation of the terahertz-wave signal to a radiation direction and a focusing direction.

Normally, the transmission device 5 restricts the terahertz-wave signal of the three-dimensional beam, which moves in a free space, in the Z dimension (up-and-down direction) of the thin semiconductor substrate of the waveguide unit 3, and confines the terahertz-wave signal in the dielectric slab mode of the XY dimension (planar direction). Thereby, spatial optical elements with a broad band can be used, and transmission characteristics have high efficiency in a broad band.

In addition, the beam splitter unit 4 of the transmission device 5 can adjust the reflectance and can freely set the reflection and transmission of the terahertz-wave signal, by adjusting the magnitude of the diameter of the through-hole 51 and the pitch (distance between through-holes) in accordance with the wavelength (frequency) of the terahertz-wave signal that is propagated.

Besides, the transmission device 5 can be formed by using a general dielectric material, without being limited to the semiconductor substrate, since the transmission device 5 utilizes the properties of a dielectric.

Furthermore, the mechanical strength of the transmission device 5 is enhanced by disposing a semiconductor waveguide (the first waveguide 24 in this example) in front of the planar lens unit.

[Modifications of the Beam Splitter Unit]

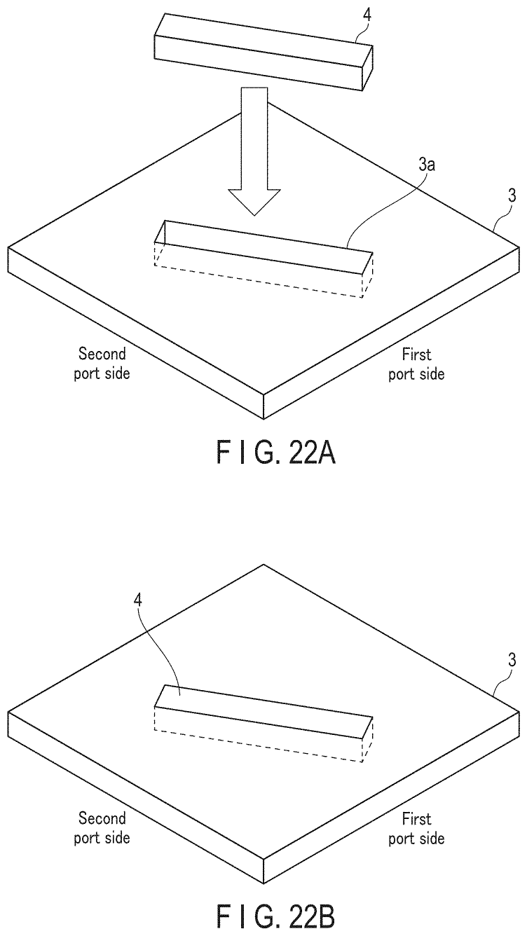

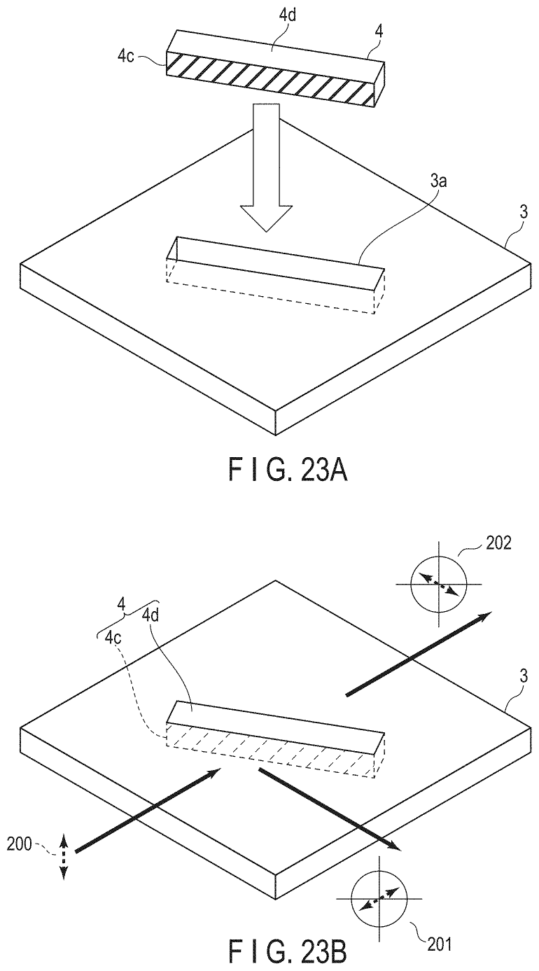

Next, modifications of the beam splitter unit will be described with reference to FIG. 2, FIG. 10, FIG. 11, FIG. 22A, FIG. 22B, FIG. 23A and FIG. 23B.

The above-described beam splitter unit 4 is the example in which the beam splitter unit 4 is formed in the transmission device 5 of the silicon semiconductor substrate which forms the first to third planar lens units 22, 32 and 42 and first to third photonic crystal waveguides 23, 33 and 43. In this case, since the beam splitter unit 4 is formed by using the silicon semiconductor substrate as the material thereof, the action (or function) on the terahertz-wave signal is limited to reflection, transmission, or the like.

Thus, in the present modification, in the action on the terahertz-wave signal by the beam splitter unit 4, an additional action, which will be described later, is realized in addition to reflection or transmission. In order to realize this, the beam splitter unit 4 is formed by using materials including a material other than the material of the silicon semiconductor substrate of the above-described embodiment. In the present modification, the beam splitter unit 4 is formed by using one of, or a combination of, a dielectric material, the above-described semiconductor materials including Si, InP, GaAs, GaN or the like, a metallic material, and a magnetic material. In the description below, when a plurality of materials are combined, a stacked structure, in which layers of materials are stacked, is basically adopted, and this stacked structure is referred to as “hybrid structure”. Needless to say, aside from the stacked structure, for example, an alloy in which a plurality of metals are fused, or a mixed material in which a plurality of materials are mixed, can also be used.

As the dielectric material of the beam splitter unit 4, for example, use can be made of quartz, Teflon (trademark), polyethylene, polymethypentene (trademark), polyimide, cycloolefin, pellicle, or the like. As the metallic material, use can be made of gold, silver, copper, aluminum, or tungsten, or an alloy thereof, or the like.

When the beam splitter unit is formed of a material different from the material of the semiconductor substrate in which the above-described planar lens units 22, 32 and 42 and waveguides 23, 33 and 43 are formed, there is a fabrication method, as a first fabrication method, in which a beam splitter unit 4 formed as a single piece is buried and integrated in the waveguide unit 3 of the semiconductor substrate. In this fabrication method, to begin with, a material suited to the specifications and design of the transmission device 5 is selected from among the above-described materials of the beam splitter unit 4.

As illustrated in FIG. 22A, a solid beam splitter unit 4 is formed of a selected material as a single piece. In this formation, the air content rate ζ is set based on the reflection and transmission of the terahertz-wave signal used in the beam splitter unit. A grid arrangement having the hole diameter D2 and inter-hole distance (pitch Pa2) of through-holes 51, by which this air content rate ζ is obtained, is formed. As regards the through-holes 51, the formation method suited to the selected material is selected. The formation method can utilize, for example, physical cutting by irradiation of a laser beam or dry etching or the like relating to semiconductor fabrication technology, or chemical cutting such as wet etching.

Next, the beam splitter unit 4 is cut to a size according to design, or the size of the beam splitter unit 4 is adjusted. It is possible to use the above-described physical cutting, chemical cutting, or mechanical cutting using a drill or a polishing device. Subsequently, in the waveguide unit 3 of the semiconductor substrate, a position of formation of a hole 3a (or a trench [bottomed hole]) for burying the beam splitter unit 4 is set by taking into account the reflection position and reflection direction of the terahertz-wave signal of the slab mode, which is transmitted through the first to third planar lens units 22, 32 and 42. Further, the hole 3a for the burying is formed by the above-described irradiation of the laser beam or by the etching relating to the semiconductor fabrication technology.

Following the above, as illustrated in FIG. 22B, the beam splitter unit is buried in the hole 3a formed in the semiconductor substrate, side surfaces of the hole 3a and side surfaces of the beam splitter unit are adhered in close contact by using an adhesive or the like, and the semiconductor substrate and the beam splitter unit 4 are integrated.

In addition, the beam splitter unit 4 can be configured to have various functions by combining the above-described materials. As illustrated in FIG. 23A, for example, the beam splitter unit may have a hybrid structure in which two layers of different kinds of materials are stacked such that the terahertz-wave signal of the slab mode passes through each layer.

As a first example of the beam splitter unit 4 of the hybrid structure, when materials with different refractive indices are used, even if the grid arrangement is formed by the through-holes 51 with the same inter-hole distance and the same hole diameter, the reflection angle or transmission angle is different since the refractive indices are different. Thus, the terahertz-wave signal can be branched in at least two different directions, and can be reflected or transmitted. In addition, as a second example of the beam splitter unit 4, there is a hybrid structure in which two kinds of materials that pass signals of different specific wavelengths (or specific frequencies) are stacked. In the case of this second example, when a terahertz-wave signal in which plural wavelengths (or frequencies) are mixed is transmitted, a terahertz-wave signal of a specific wavelength passes through the beam splitter unit and a terahertz-wave signal other than the specific wavelength is reflected. In short, the beam splitter unit has a filter function.

Further, as illustrated in FIG. 23A, as a third example of the beam splitter unit 4, there is a hybrid structure in which a polarizing layer 4c that passes a signal polarized in a specific direction is disposed as an upper layer, and a metallic layer 4c serving as a support substrate is disposed as a lower layer. In the case of the third example, when a terahertz-wave signal 200 shown in FIG. 23B, in which a plurality of wavelengths (or frequencies) are mixed, is transmitted, a terahertz-wave signal 202 polarized in a specific direction is transmitted (passed) through the beam splitter unit 4, and the other terahertz-wave signal 201 is reflected. In short, the beam splitter unit 4 has a selecting function of the terahertz-wave signal by the polarizing function.

In the configuration of the this modification, the waveguide unit 3 is formed in the same semiconductor substrate as the first to third planar lens units 22, 32 and 42, and only the beam splitter unit 4 is formed as a single piece (separate piece) and buried in the waveguide unit 3. However, this modification is not limited to this. For example, the waveguide unit 3 is formed in a dielectric substrate which is a separate piece from the first to third planar lens units 22, 32 and 42, and a beam, splitter unit 4 formed as a single piece is buried in the waveguide unit 3. Alternatively, such a configuration may be adopted that the waveguide unit which the beam splitter unit 4 is fitted, is fitted in the semiconductor substrate in which the first to third planar lens units 22, 32 and 42 are formed. In this configuration, the waveguide unit 3 having different characteristics from the first to third planar lens units 22, 32 and 42 can be formed, and the reflectance or transmittance of the beam splitter unit 4 can be set as appropriate.

### SECOND APPLICATION EXAMPLE

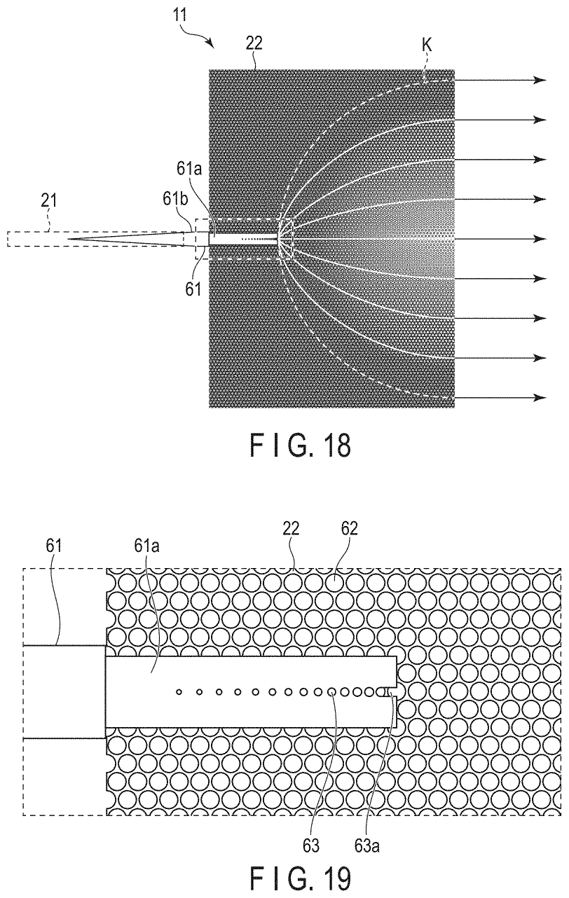

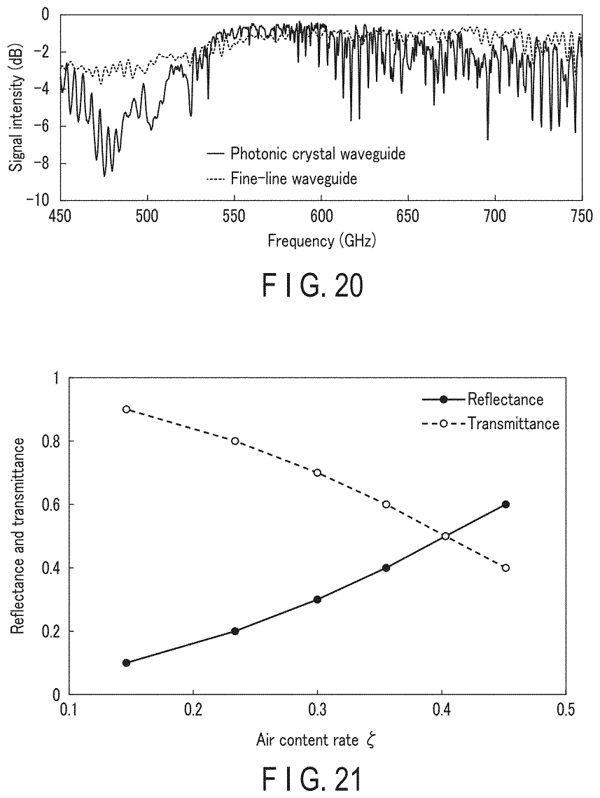

Referring to FIG. 18 to FIG. 20, a description will be given of a second application example in which dielectric slot waveguides (or slot waveguides) are used in the first to third ports 11, 12 and 13. FIG. 18 is a view illustrating a configuration example of a first port including a dielectric slot waveguide unit according to the second application example. FIG. 19 is an enlarged view illustrating, in enlarged scale, a coupling portion between the dielectric slot waveguide and a planar lens unit. FIG. 20 is a view illustrating characteristics of signal intensity of transmittance in a planar lens unit using a photonic crystal waveguide and a planar lens unit using a dielectric slot waveguide. In the second application example, like the above-described first application example, the first to third ports 11, 12 and 13 are identically configured to include dielectric slot waveguides, and the first port is representatively described here by way of example.

A first dielectric slot waveguide 61 is configured such that, for example, one end 61a of the dielectric slot waveguide 61 is linearly fitted in the first planar lens unit 22 formed in the silicon semiconductor substrate having a thickness of 200 μm. Specifically, in this configuration, the first waveguide 24 is not provided on both sides of the dielectric slot waveguide 61 in front of the first planar lens unit 22. The first dielectric slot waveguide 61 confines the electromagnetic waves of the terahertz-wave signal in a dielectric slot waveguide by a difference in refractive index. This dielectric slot waveguide is configured such that the planar lens unit, which is disposed on both sides of the waveguide in the above-described photonic crystal waveguide, is not provided.

The first dielectric slot waveguide 61 is formed at the same time as the first planar lens unit 22. The first dielectric slot waveguide 61 has a rectangular cross section. Like the above-described first waveguide 24, the other end 61b of the dielectric slot waveguide 61 has a tapering shape decreasing in thickness toward the distal end with an elongated prismatic shape, and is inserted in and coupled to the first metallic waveguide tube 21 that is formed of a metallic material.

The coupling portion illustrated in FIG. 19 has such a structure that one end 61a of the dielectric slot waveguide 61 is linearly disposed into the first planar lens unit 22. Through-holes 62 of the first planar lens unit 22, which are in contact with both side surfaces of the one end 61a, are formed such that conical surfaces (cut surfaces) located on the diameters of semicylinders come in contact with the side surfaces of the one end 61a.

In addition, a row of through-holes (fourth through-holes) 63 with diameters gradually increasing toward the waveguide unit 3 are formed in a central portion of the one end 61a of the dielectric slot waveguide 61 which is coupled to the first planar lens unit 22. Besides, a U-shaped notch 63a is formed, as needed, in a distal portion of the one end 61a of the dielectric slut waveguide 61, in order to relax a step of an impedance value between the first planar lens unit 22 and the dielectric slot waveguide 61, and to control the direction of travel of the terahertz-wave signal. The through-holes 63 make impedance matching between the dielectric slot waveguide 61 and the first planar lens unit 22, and prevent the occurrence of reflective waves of the terahertz-wave signal which is electromagnetic waves. In addition, the through-holes 63 for impedance matching in this coupling portion are applicable to the above-described coupling portion between the photonic crystal waveguide and the planar lens unit. Needless to say, the arrangement and the magnitude of the diameter of the through-holes 63 shown in FIG. 19 are merely examples, and the through-holes 63 may have similar configurations to the above-described through-holes 24a for making impedance matching between the first waveguide 24 and the first planar lens unit 22.

Next, referring to FIG. 20, a description will be given of the signal intensity of transmittance in the planar lens unit using a photonic crystal waveguide and in the planar lens unit using a dielectric slot waveguide, relative to the frequency of the terahertz-wave signal that is propagated.

As illustrated in FIG. 20, the signal intensity (dB) of transmittance acquired from the planar lens unit using the dielectric slot waveguide is in a range of −1 to −3 (dB) in a broad band of actually measured frequencies of 450 GHz to 750 GHz, and has flat characteristics with relatively small variations.

By contrast, the signal intensity acquired from the planar lens unit using the photonic crystal waveguide has a lower level than the signal intensity (dB) acquired from the planar lens unit using the dielectric slot waveguide, except for the frequencies of 540 GHz to 600 GHz, and has greater variations relative to the frequency. The cause of this is assumed to be that a “wall” is formed between the photonic crystal waveguide 23 and the waveguide unit 3, and a variation in reflectance occurs due to multiple reflection. However, the structure using the photonic crystal waveguide has a higher strength than the structure using the dielectric slot waveguide, and is in a practical level. In addition, in the narrow band in which the band of frequencies of the terahertz-wave signal that is used is limited, the characteristics of the structure using the photonic crystal waveguide do not greatly different from the characteristics of the structure using the dielectric slot waveguide, and the structure using the photonic crystal waveguide can be practically used.

The transmission devices 5 in the above-described first application example and the second application example can be applied to, for example, an inspection system which radiates a terahertz-wave signal to an examination target by using the terahertz-wave signal as an inspection signal, and images an internal structure of the examination target in a nondestructive manner as image information.

In addition, since the terahertz-wave signal has higher directivity than microwaves or millimeter waves, it becomes difficult to adjust the positions of optical elements such as the transmission path, lens, beam splitter and the like. However, the transmission device 5 of the present embodiment is integrally formed on the semiconductor substrate by using the semiconductor fabrication process. Thus, when the transmission device 5 is mounted in the inspection system, only the position adjustment of the objective lens 9 and scan unit 8 is necessary, and the apparatus manufacture becomes not only smaller in scale but also easier, and the number of fabrication steps and the manufacturing staff can be reduced, and the cost can be reduced.

While the embodiments and application examples of the present invention have been described, these embodiments, etc. have been presented by way of example only, and are not intended to limit the scope of the inventions. These embodiments, etc. may be implemented in a variety of other forms, and various omissions, substitutions and changes may be made without departing from the spirit of the inventions. The embodiments and modifications are included in the scope and spirit of the invention, and also included in the scope of the inventions stated in the claims and their equivalents.

1. A transmission device comprising:
a first waveguide formed on a planar substrate with dielectric properties, having a width set by a frequency of a terahertz-wave signal, and configured to propagate the terahertz-wave signal; and
a first planar lens including a first hole array formed in the substrate and arranged in a staggering manner, connected to the first waveguide to transmit and receive the terahertz-wave signal, and configured to diffuse the terahertz-wave signal that passes, and to convert the passing terahertz-wave signal into parallel waves, or configured to focus the terahertz-wave signal of parallel waves that pass, by a first refractive index set by hole diameters of the first through-holes and an inter-hole distance of the first through-holes.

2. The transmission device of claim 1, wherein
the transmission device comprises:
the first waveguide configured to propagate the terahertz-wave signal; and
the first planar lens configured to diffuse the terahertz-wave signal in an arcuate shape, and to convert the terahertz-wave signal into parallel waves, and
the transmission device further comprises:
a transmission path connected to the first planar lens on the substrate and configured to transmit the terahertz-wave signal converted into the parallel waves from the first planar lens;
a second planar lens formed on the connected to the transmission path, including the first through-holes arranged in the staggering manner, and configured to focus, with respect to the passing terahertz-wave signal, the terahertz-wave signal of the parallel waves transmitted from the transmission path, by the first refractive index set by the first through-holes, or configured to diffuse a reflective signal of the terahertz-wave signal by the first refractive index, and to convert the reflective signal into parallel waves; and
a second waveguide formed on the substrate, connected to the second planar lens, having a width set by a frequency of the focused terahertz-wave signal, and configured to output the terahertz-wave signal which is input from the second planar lens, or configured to propagate a reflective signal of the terahertz-wave signal, which is input from an outside, to the second planar lens.

3. The transmission device of claim 2, wherein
the transmission device includes a beam splitter formed in the transmission path in a strip shape by a grid arrangement of a second hole array by using one of materials of a dielectric material, a semiconductor material, a conductor material and a magnetic material, or a combination of two or more of the materials, and configured to propagate, by reflection or transmission by a second refractive index set by a content rate of a gas by the second through-holes in a region of the strip shape, the terahertz-wave signal of the parallel waves, which is transmitted from the first planar lens, to the second planar lens, the beam splitter being formed as a single piece and integrated in the substrate, or being formed together with the transmission path in the substrate.

4. The transmission device of claim 2, wherein
the first waveguide and the first planar lens constitute a first port which supplies the terahertz-wave signal,
the second waveguide and the second planar lens constitute a second port which transmits and receives the terahertz-wave signal, and
the transmission device further comprises a third port configured to perform signal reception, the third port including:
a third planar lens configured to focus, in an arcuate shape, the reflective signal of the terahertz-wave signal of the parallel waves, the reflective signal being taken in from the second port and transmitted through or reflected by the beam splitter; and
a third waveguide configured to receive the reflective signal of the terahertz-wave signal focused by the third planar lens, to confine the reflective signal and to propagate the reflective signal.

5. The transmission device of claim 4, further comprising:
a first photonic crystal waveguide configured such that a third hole array each having a greater diameter than each of the first through-holes are arranged in a staggering manner on both side surfaces of the first waveguide, configured such that both the side surfaces of the first waveguide are covered by the third through-holes having semicylindrical shapes, and configured to propagate the terahertz-wave signal by confining the terahertz-wave signal in the first waveguide;
a second photonic crystal waveguide configured such that a third hole array each having a greater diameter than each of the first through-holes are arranged in a staggering manner on both side surfaces of the second waveguide, configured such that both the side surfaces of the second waveguide are covered by the third through-holes having semicylindrical shapes, and configured to propagate the terahertz-wave signal by confining the terahertz-wave signal in the second waveguide; and
a third photonic crystal waveguide configured such that a third hole array each having a greater diameter than each of the first through-holes are arranged in a staggering manner on both side surfaces of the third waveguide, configured such that both the side surfaces of the third waveguide are covered by the third through-holes having semicylindrical shapes, and configured to propagate the terahertz-wave signal by confining the terahertz-wave signal in the third waveguide.

6. The transmission device of claim 3, wherein
a ratio between the reflection and the transmission of the terahertz-wave signal that is incident on the beam splitter has such a relationship that a reflectance of the reflection increases and a transmittance of the transmission decreases, in accordance with an increase of a content rate of air existing in the second through-holes, relative to a formation region of the substrate where the beam splitter is formed.

7. The transmission device of claim 3, wherein
the beam splitter disposed in the transmission path includes a stacked structure by layers of at least two materials having mutually different refractive indices, and
the beam splitter is configured to branch the terahertz-wave signal, which passes by different refractive indices, in two different directions by different reflection angles or transmission angles, and to reflect or transmit the terahertz-wave signal.

8. The transmission device of claim 3, wherein
the beam splitter disposed in the transmission path includes a polarizing layer which passes a polarized signal of the terahertz-wave signal which is polarized in a specific direction, and
the beam splitter is configured to transmit the terahertz-wave signal polarized in the specific direction passes, and to reflect a terahertz-wave signal other than the terahertz-wave signal polarized in the specific direction.

9. The transmission device of claim 5, wherein
each of a first coupling portion in which the first planar lens and the first waveguide are coupled, a second coupling portion in which the second planar lens and the second waveguide are coupled, and a third coupling portion in which the third planar lens and the third waveguide are coupled, includes a coupling unit configured to make impedance matching, and
the coupling unit includes a fourth hole array which are disposed in a triangular grid arrangement and have gradually increasing diameters from the first to third waveguides toward the first to third planar lenses.

10. The transmission device of claim 5, wherein
each of a first coupling portion in which the first planar lens and the first waveguide are coupled, a second coupling portion in which the second planar lens and the second waveguide are coupled, and a third coupling portion in which the third planar lens and the third waveguide are coupled, includes a coupling unit configured to make impedance matching, and
the coupling unit includes a fourth hole array which are disposed in a row and have gradually increasing diameters from the first to third waveguides toward the first to third planar lenses.

11. The transmission device of claim 1, wherein
a refractive index of each of the first planar lens and the second planar lens is given by an equation below,
$$n ( r ) = \frac{{n}_{max}}{1 + {( \frac{r}{{r}_{max}} )}^{2}} \qquad ( 1 )$$
where nₘₐₓ is a maximum refractive index in a state in which the first through-holes are not provided in a lens, rₘₐₓ is a maximum radius of the lens, r is a radial position inside the lens, a is an inter-center distance between the first through-holes which mutually neighbor, and D1 is a diameter of the first through-hole, which is equal to or less than ¼ of a wavelength.

12. The transmission device of claim 2, wherein
each of the first waveguide, the second waveguide and the third waveguide is connected to a proximal end of a metallic waveguide tube having a rectangular cross section gradually spreading in a taper shape from a tip end thereof.

13. A system including the transmission device, comprising:
the transmission device of claim 4;
a transmitter configured to emit and output a terahertz-wave signal to the first port of the transmission device;
an optical system configured to receive, from the second port, the terahertz-wave signal which is propagated from the first port and reflected by or transmitted through the beam splitter of the waveguide unit, configured to emit the terahertz-wave signal to a freely selected target, and configured to receive a reflective signal of the terahertz-wave signal from the target; and
a receiver configured to receive the reflective signal of the terahertz-wave signal which is propagating from the optical system through the second port and transmitted through or reflected by the beam splitter.
